(19) United States
(12) Patent Application Publication
(10) Pub. No.: US 2008/0308079 A1
(43) Pub. Date: Dec. 18, 2008

(54) Exhaust Gas Recycling Device Comprising a Flow Regulating and Selectively Connecting Valve

(75) Inventor: Laurent Albert, Vallangoujard (FR)

Correspondence Address: OSHA LIANG L.L.P., TWO HOUSTON CENTER, 909 FANNIN, SUITE 3500, HOUSTON, TX, 77010, US

(73) Assignee: VALEO SYSTEMES DE CONTROLE MOTEUR, Osny (FR)

(21) Appl. No.: 11/817,995

(22) PCT Filed: Mar. 8, 2006
(86) PCT No.: PCT/FR2006/000512

§ 371 Date: Apr. 16, 2008

(30) Foreign Application Priority Data
Mar. 9, 2005 (FR) 0502347

(51) Int. Cl. F02M 25/07; F16K 3/04

(52) U.S. Cl. 123/568.11; 251/303

(57) ABSTRACT

The invention concerns an exhaust gas recycling device comprising a cooled path (5) and a non-cooled path (6) connected through a selective connection means (7) to a conduit (14) provided with a valve (7) including a chamber (9) connected to the conduit and accommodating a mobile flow regulating element and perforated with a passage orifice (16) for defining a variable cross-section for allowing through exhaust gases. The cooled and non-cooled paths have each one end opening on to a wall (10) of the chamber and the regulating element is mounted opposite said wall to be mobile between a first extreme position wherein the passage orifice is opposite the cooled path and a second extreme position wherein the passage orifice is opposite the non-cooled path, the regulating element having an intermediate position wherein the regulating element closes the cooled and non-cooled paths.

The present invention relates to an exhaust gas recirculation device that can be used in particular to reinject some of the exhaust gases into the intake circuit of a combustion engine.

### BACKGROUND OF THE INVENTION

An exhaust gas recirculation device generally comprises a cooled path and an uncooled path which are connected by a selective connecting member to a pipe which is connected to the intake circuit of the engine and which is provided with a flow regulating valve. The selective connecting member comprises a chamber into which the cooled and uncooled paths open, and a valve element that can move in the chamber between a position in which the uncooled path is connected and the cooled path is closed off and a position in which the cooled path is connected and the uncooled path is closed off. The valve is mounted between two pipe portions and comprises a body delimiting a chamber into which the pipe portions open, a flow regulating element pierced with a through-orifice being mounted to move in the chamber in order to define a variable cross section through which the exhaust gases can pass. This exhaust gas recirculation device has a structure that is relatively complicated and bulky.

### SUBJECT OF THE INVENTION

It would therefore be beneficial to have an exhaust gas recirculation device which is simple and compact.

### BRIEF DESCRIPTION OF THE INVENTION

For this purpose, the invention provides an exhaust gas recirculation device comprising a cooled path and an uncooled path which are connected by a selective connecting means to a pipe provided with a valve comprising a chamber connected to the pipe and housing a flow regulating element that is able to move and is pierced with a through-orifice so as to define a variable cross section for the passage of the exhaust gases, the cooled and uncoated paths each having an end opening onto a wall of the chamber and the regulating element being mounted facing this wall so as to be able to move between a first extreme position in which the through-orifice faces the cooled path and a second extreme position in which the through-orifice faces the uncooled path, the regulating element having an intermediate position in which the regulating element closes off the cooled and uncoated paths.

Thus, causing the regulating element to move from its intermediate position into its first extreme position allows the flow of exhaust gases from the cooled path to be regulated, while causing the regulating element to move from its intermediate position into its second extreme position allows the flow of exhaust gases from the uncooled path to be regulated. The flow in the pipe can thus be regulated. Furthermore, when the regulating element is in one of its extreme positions or in its intermediate position, the regulating element selectively connects the cooled and uncooled paths to the pipe. The valve in this way performs a dual function of regulating the flow and of selecting which path is connected to the pipe. Furthermore, the regulating element can be moved in a plane perpendicular to the flow of exhaust gases which means that the means used to move the regulating element are only to a limited extent called upon to be able to withstand the forces exerted on the regulating element by the pressurized exhaust gases.

According to one particular embodiment, the regulating element is formed of a disk mounted in the chamber to pivot between its two extreme positions.

The disk can be made to move in a particularly simple way using an electric motor for example. This structure of the valve is particularly compact.

As a preference, the three positions of the disk are spaced 120° apart.

This arrangement makes it possible to obtain the largest passage cross section for a given size.

According to one advantageous feature, the disk and the wall are in contact via at least one first collar surrounding the through-orifice and, as a preference, the disk and the wall are also in contact via at least one second collar symmetric with the first collar with respect to an axis of rotation of the disk.

Sealing is thus achieved over a relatively small area, namely the edge of the collar, making it easier to obtain a good seal. Furthermore, making several symmetric collars allows the forces with which the disk is pressed against the wall to be spread.

According to another advantageous feature, the valve comprises a return element for returning the disk to the intermediate position and, as a preference, the return element comprises two torsion springs connected to the disk and to the body so as to exert opposing return torques on the disk.

The valve is then in the position in which it closes off both paths when no power is applied to it.

Other features and advantages of the invention will emerge from reading the description which follows of some particular nonlimiting embodiments of the invention.

### BRIEF DESCRIPTION OF THE DRAWINGS

Reference will be made to the attached drawings, among which:

FIG. 1 is a schematic view of a combustion engine equipped with an exhaust gas recirculation device,

FIG. 2 is a view in axial section of a valve according to the invention for the first position of the regulating element,

FIG. 3 is a view similar to that of FIG. 2 for a second position of the regulating element,

FIG. 4 is a view from above of the wall that forms the seat for the regulating element,

FIG. 5 is a view similar to that of FIG. 3 of a valve according to an alternative form of embodiment.

### DETAILED DESCRIPTION OF THE INVENTION

With reference to FIG. 1, the exhaust gas recirculation device, denoted in general by 1, is intended to be fitted to a combustion engine 2 being connected, on the one hand, to the burnt gases exhaust pipe 3 and, on the other hand, to the air intake pipe 4. This arrangement is known per se.

The recirculation device 1 comprises a cooled path 5 and an uncooled path 6 which are known per se and which are connected, on the one hand, to the exhaust pipe 3 and, on the other hand, to the intake pipe 4 via a valve 7.

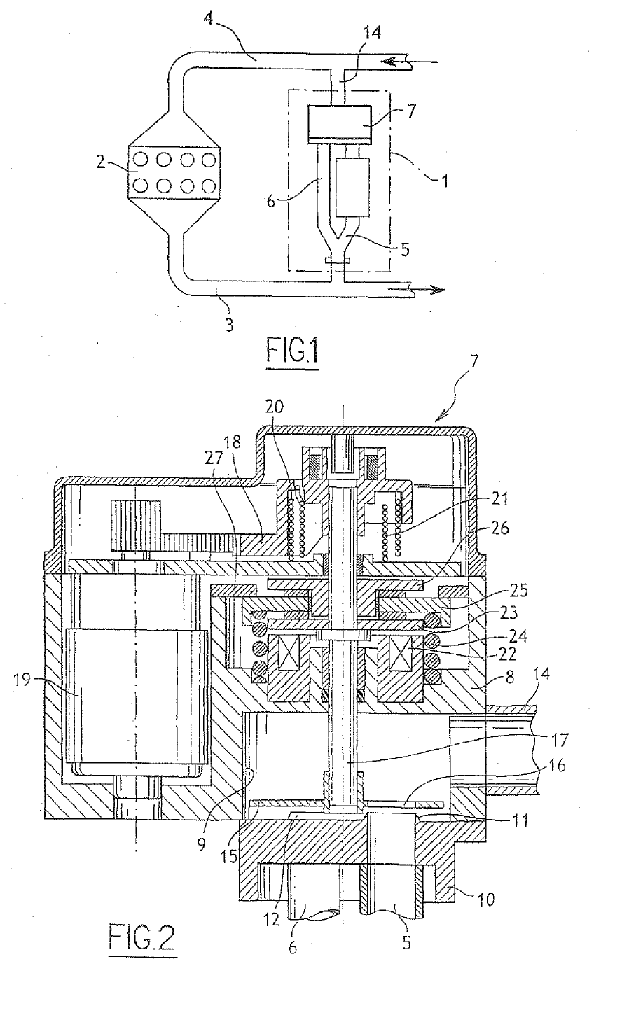

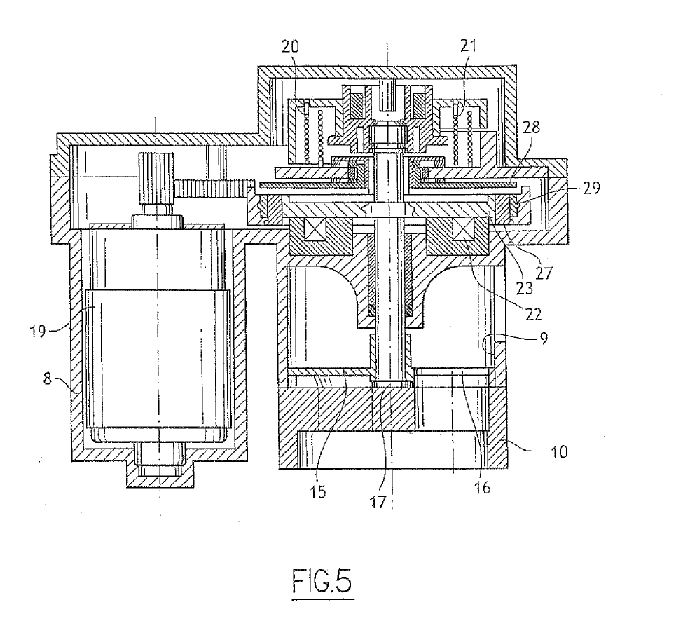

With reference also to FIGS. 2 to 4, the valve 7 comprises a body 8 which delimits a chamber 9 closed by a flange 10 pierced with passages to which the corresponding ends of the cooled 5 and uncooled 6 paths are connected. The flange 10 is fixed to the body 8 removably, for example using screws that cannot be seen in the figures, and forms one wall of the chamber 9. The flange 10 comprises, on the same side as the chamber 9, a surface, from which a first collar 11 surrounding the mouth of the cooled path 5, a collar 12 surrounding the mouth of the uncooled path 6 and a blind collar 13 project, 120° apart from one another. The collars 11, 12 and 13 are identical.

The chamber 9 is connected to the intake pipe 4 by a connecting pipe 14 that opens into the chamber 9.

The chamber 9 accommodates a flow regulating element formed of a disk 15 pierced with a through-orifice 16 of a cross section comparable with that of the cooled 5 and uncooled 6 paths. The disk 15 lies facing the collars 11, 12, 13 and the flange 10. The disk 15 is secured to one end of a shaft 17, an opposite end of which is secured to a toothed sector 18 rotated off an electric motor 19, in this incidence, a DC motor.

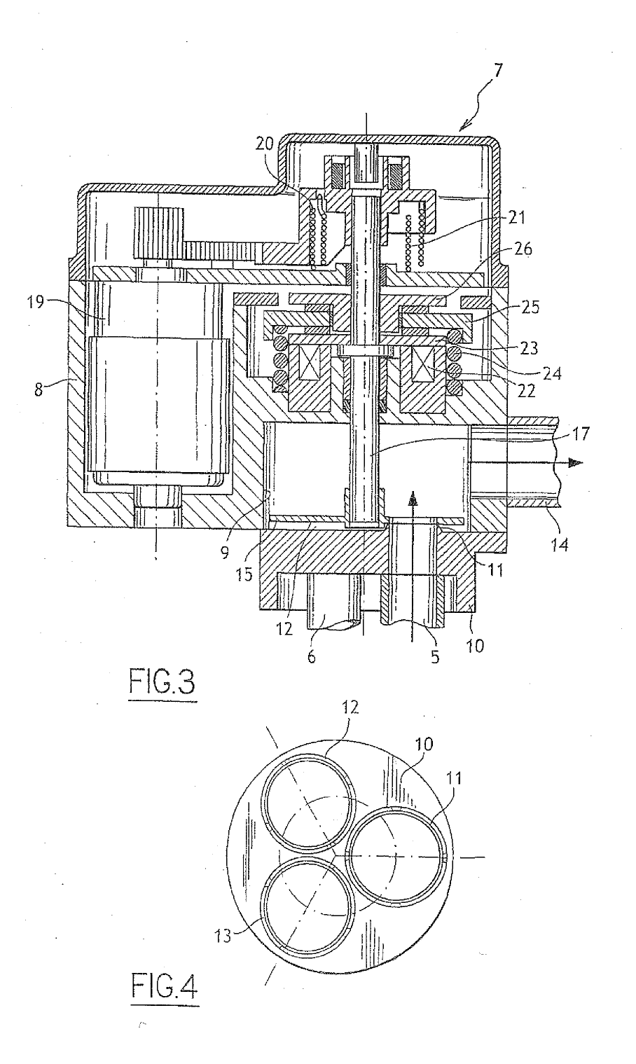

The disk 15 can thus be rotated between two extreme positions, namely:
a first extreme position (depicted in FIGS. 2 and 3) in which the through-orifice 16 lies facing the collar 11 and therefore the cooled path 5 (the disk 15 therefore uncovers the cooled path 5 and closes off the uncooled path 6), and
a second extreme position (not depicted) in which the through-orifice 16 lies facing the collar 12 and therefore the uncooled path 6 (the disk 15 then uncovers the uncooled path 6 and closes off the cooled path 5).

Between these two extreme positions, the disk 15 has an intermediate position (not depicted) in which the through-orifice 16 faces the collar 13, the disk 15 closing off the cooled 5 and uncooled 6 paths. The two extreme positions and the intermediate position are 120° apart. This 120° separation between the positions makes it possible to have the largest passage cross section for a given size.

The valve 7 comprises a return element returning the disk 15 to the intermediate position. The return element comprises two torsion springs 20, 21 which are helical springs coaxial with the shaft 17, each having one end connected to the toothed sector 18 and one end connected to the body 8 so as to exert on the toothed sector 18, and therefore on the disk 15, opposing return torques.

The shaft 17 is housed in the body 8, not only such that it can pivot, but also such that it can slide so that the disk 15 can move between two axial positions, namely:
a seated first position (depicted in FIG. 3) in which the disk 15 is pressed against the collars 11, 12, 13, the collars 11, 12, 13 forming the seat for the disk 15, and
an unseated second position (depicted in FIG. 2) in which the disk 15 is away from the collars 11, 12, 13.

The valve 7 comprises movement means for moving the disk 15 between its seated position and its unseated position.

The movement means comprise a coil 22 fixed to the body 8 coaxial with respect to the shaft 17 so that it lies facing a plate 23 of magnetic material which undergoes a translational movement as one with the shaft 17. The coil 22 is connected to electrical power supply means, not depicted, in such a way that when power is applied to the coil 22 it attracts the plate 23 and moves the shaft 17 and the disk 15 towards the seated position of the disk 15.

The movement means also comprise a return member for returning the disk 15 to the unseated position. The return means comprises a helical compression spring 24 which is positioned coaxially with respect to the shaft 17 between the body 8 and a plate 25 which is fixed in terms of translation but free to turn with respect to the shaft 17. In this particular instance, the plate 25 is mounted such that it is free to rotate on a stepped bushing 26 secured to the shaft 17 and bears axially against the shoulder of the bushing 26 and against the plate 23 via sliding shoes or needle thrust bearings. The spring 24 pushes the plate 25 back against an end stop 27 secured to the body 8. The end stop 27 defines the unseated position of the disk 15.

The way in which the valve works will now be described.

When the combustion engine 2 is not running, the electric motor 19 and the coil 22 are not powered. The spring 24 holds the disk 15 in the unseated position and the torsion springs 20, 21 hold the disk 15 in the intermediate position.

Exhaust gas recirculation is managed in the way known per se by the engine control unit or by some other dedicated unit known per se, to which the electric motor 19 and, at least indirectly, the coil 22, are connected.

When the combustion engine 2 is in an exhaust gas recirculation phase, the electric motor 19 is operated in such a way that the disk 15 is brought into one or other of its two extreme positions according to whether it is the cooled path 5 or the uncooled path 6 that is to be connected to the intake pipe 4 by the connecting pipe 14. It will be understood that, when the disk 15 is in one of its two extreme positions, it allows maximum flow rate because the through-orifice 16 is fully facing one of the two paths 5, 6. By contrast, when the disk 15 is between its intermediate closing-off position and one of its extreme positions, the through-orifice 16 lies only partially facing one of the two paths which means that the disk 15 closes off part of this path. The disk 15 thus reduces the cross sectional area available for the passage of the flow of exhaust gases from the path in question and thus regulates the flow.

It will be noted that when the disk 15 is in the unseated position and the combustion engine is in the recirculation phase, there is a leakage at the mouth of the path facing which the disk 15 lies for closing this path off. This leakage has a negligible flow rate.

When the disk 15 pivots between its extreme positions it is not pressed against the collars 11, 12, 13. That makes it possible to limit friction and therefore the wearing of the contacting parts. The angular position of the disk 15 is detected in the conventional way.

Outside of exhaust gas recirculation phases, the electric motor 19 brings the disk 15 into its intermediate position and the coil 22 is powered and keeps the disk 15 in the seated position.

In order to make the disk 15 move between its various angular positions if there is a return to the recirculation phase, the power supply to the coil 22 is cut off beforehand so that the spring 24 can move the disk 15 into its unseated position, then the electric motor 19 is powered in such a way as to move the disk 15 into the desired position.

The presence of the collars 11, 12, 13 makes it possible to simplify the way in which a seal is achieved between the disk 15 and its seat and makes it possible to balance the loads exerted on the disk 15 when the disk is in the seated position.

The valve 7 performs a dual function of regulating the flow and selecting which path 5, 6 is connected to the pipe 14. Furthermore, since the disk 15 is moved in a plane perpendicular to the flow of the exhaust gases, the means used to move the disk 15 are only to a limited extent called upon to withstand the forces exerted on the disk 15 by the pressurized exhaust gases.

When the combustion engine 2 is switched off, the supply of power to the coil 22 is cut off so that the spring 24 pushes the disk 15 back into the unseated position. The possibility of particles or agglomerates contained in the exhaust gases sticking the disk 15 to the flange 10 is thus avoided.

According to an alternative form of embodiment depicted in FIG. 5, the return member returning the disk 15 to the unseated position comprises a permanent magnet 27, of circular shape, fixed around the periphery of the plate 23 facing a magnetic plate 28 which is fixed in terms of translation but free to turn with respect to the body 8. The magnetic plate 28 is coaxial with the shaft 17 and is fixed to the body 8 by a rotational-guidance bearing and axial needle thrust bearings. The plate 23 is made of magnetic material.

The permanent magnet 27 has a diameter greater than that of the coil 22.

The permanent magnet 27 is associated with an armature 29 through which the magnetic flux generated by the permanent magnet 27 flows so that the permanent magnet 27 generates an attractive force attracting the magnetic plate 28.

The armature 29 comprises, in a way known per se, a saturating section restricting the flux generated by the permanent magnet 27 so as to limit the increase in the force of attraction produced by the permanent magnet 27 as the permanent magnet approaches the plate 28. This makes it easier for the coil 22 to move the disk 15 when this coil is powered in such a way as to move the disk 15 into the seated position in which it is pressed against the collars 11, 12, 13.

Thus, when the coil 22 is powered, it attracts the plate 23 and brings the disk 15 into the seated position. When the supply of power to the coil 22 is cut off, the permanent magnet 27 attracts the plate 28 and carries the disk 15 into the unseated position.

The difference in diameter between the permanent magnet 27 and the coil 22 is such that the permanent magnet 27 and the coil 22 are separated from one another so that the permanent magnet 27 is subjected little, if at all, to the magnetic field generated by the coil 22.

In this alternative form of embodiment, the toothed sector driven by the electric motor 19 is secured to the plate 23.

The torsion springs 20, 21, which are helical and coaxial with the shaft 17, each have an end connected to a part that rotates as one with the shaft 17 and an end connected to the body 8 so as to exert opposing return torques on the shaft 17 and therefore on the disk 15.

In this alternative form of embodiment too, the surface of the flange 10 lying on the same side as the chamber 9 is plain and the disk 15 has three projecting collars (only two collars can be seen in FIG. 5): one collar surrounding the through-orifice 16 and two blind collars.

The way in which the valve according to this alternative form of embodiment works is identical to the mode of operation already described.

Of course, the invention is not restricted to the embodiment described and alternative forms of embodiment may be applied thereto without departing from the scope of the invention as defined by the claims.

In particular, the regulating element could have a structure different from that described and could, for example, consist of a sliding plate.

Furthermore, the paths 5 and 6 could be connected directly to the chamber 9 by connection end pieces arranged externally on the body 8.

The collars 11, 12, 13 are optional.

The valve 7 may be mounted upstream of the cooled and uncooled paths rather than downstream as depicted in FIG. 1.

During the recirculation phase, provision may be made for the disk 15 to be brought into the seated position once this disk is in the desired angular position connecting one of the paths to the pipe 14 if it is not desirable for there to be any leakage on the other path. If the angular position were to be changed, the disk 15 would be unseated beforehand, and then, once it has been pivoted, returned to its seated position.

1. An exhaust gas recirculation device comprising a cooled path (5) and an uncooled path (6) which are connected by a selective connecting means (7) to a pipe (14) provided with a valve (7) comprising a chamber (9) connected to the pipe and housing a flow regulating element (15) that is able to move and is pierced with a through-orifice (16) so as to define a variable cross section for the passage of the exhaust gases, characterized in that the cooled and uncooled paths each have an end opening onto a wall (10) of the chamber and in that the regulating element is mounted facing this wall so as to be able to move between a first extreme position in which the through-orifice faces the cooled path and a second extreme position in which the through-orifice faces the uncooled path, the regulating element having an intermediate position in which the regulating element closes off the cooled and uncooled paths.

2. The device as claimed in claim 1, characterized in that the regulating element is formed of a disk (15) mounted in the chamber (9) to pivot between its two extreme positions.

3. The device as claimed in claim 2, characterized in that the three positions of the disk (15) are spaced 120° apart.

4. The device as claimed in claim 2, characterized in that the disk (15) and the wall (10) are in contact via at least one first collar (11) surrounding the through-orifice (16).

5. The device as claimed in claim 4, characterized in that the disk (15) and the wall (10) are also in contact via at least one second collar (12, 13) symmetric with the first collar (11) with respect to an axis of rotation of the disk.

6. The device as claimed in claim 2, characterized in that the valve (7) comprises a return element (20, 21) for returning the disk (15) to the intermediate position.

7. The device as claimed in claim 6, characterized in that the return element comprises two torsion springs (20, 21) connected to the disk (15) and to the body (8) so as to exert opposing return torques on the disk.

8. The device as claimed in claim 1, characterized in that the disk (15) can move axially between a position in which it is pressed against the wall (10) and a position in which it is away from the wall, and in that the valve (7) comprises movement means (24; 27) for moving the disk between its two axial positions.
